(19) United States
(12) Patent Application Publication
(10) Pub. No.: US 2011/0182625 A1
(43) Pub. Date: Jul. 28, 2011

(54) IMAGE FORMING APPARATUS, DEVELOPING AGENT USED THEREFOR, AND METHOD FOR MANUFACTURING THE SAME

(75) Inventor: Nobuo Tohata, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/005,901

(22) Filed: Jan. 13, 2011

Related U.S. Application Data
(60) Provisional application No. 61/299,095, filed on Jan. 28, 2010.

(51) Int. Cl. G03G 15/08; G03G 9/08

(52) U.S. Cl. 399/264; 430/108.6; 430/137.2

(57) ABSTRACT

According to one embodiment, a developing agent containing a toner particle and an aggregate of a toner dust powder having a smaller volume average particle size than a volume average particle size of the toner particle and alumina is provided.

### CROSS-REFERENCE TO RELATED APPLICATIONS

This application is based upon and claims the benefit of priority from U.S. Provisional Application No. 61/299,095, filed on Jan. 28, 2010, the entire contents of which are incorporated herein by reference.

### FIELD

Embodiments described herein relate generally to an image forming apparatus adopting an electrophotography method, an electrostatic printing method, a magnetic recording method and so on, a developing agent to be applied thereto, and a method for manufacturing the same.

### BACKGROUND

In image forming apparatuses aiming at a long life, the life of a photoreceptor is taken into consideration, too. One of the causes of deteriorating the photoreceptor is the attachment of a toner, so-called toner filming. In order to prevent this from occurring, it is generally known to add an additive having an abrasive effect, such as alumina, to the toner surface. According to this, the surface of the photoreceptor is abraded, so that the attached toner can be cleaned.

In an electrophotographic system of a contact printing mode to be used for the purpose of more enhancing the image quality, since paper comes into contact with a transfer member, a paper dust is easily produced. The produced paper dust firmly attaches onto a drum, too, thereby causing deterioration of the image quality. However, according to the related-art technologies, a cleaning effect was weak because the size of alumina which is an abrasive material is slightly small against such attachment of a paper dust. On the other hand, if the size is merely increased, or a large and firm secondary aggregate composed of alumina is used, the photoreceptor is easily scratched. In addition, in a recycle system, since such an additive is accumulated, the abrasive effect becomes too strong, so that as the life proceeds, the drum is more likely scratched.

In order to avoid this matter, it is proposed to add an aluminosilicate having a secondary aggregate size of from 1 to 10 μm onto the toner surface. However, since the aluminosilicate as the secondary aggregate is existent, its cleaning effect against the attachment of a paper dust with a small size was weak.

### BRIEF DESCRIPTION OF THE DRAWINGS

FIG. 1 is an exemplary view showing a model diagram of a developing agent according to an embodiment;

FIG. 2 is an exemplary view showing an image forming apparatus according to another embodiment; and

FIG. 3 is an exemplary view showing an example of a toner recycle apparatus to be used in the image forming apparatus shown in FIG. 2.

### DETAILED DESCRIPTION

In general, according to one embodiment, there is provided a developing agent including a toner particle and an aggregate of a toner dust powder having a smaller volume average particle size than a volume average particle size of the toner particle and alumina.

Also, according to another embodiment, as an image forming apparatus to which the foregoing developing agent is applied, there is provided an image forming apparatus including

an image carrier;

a development apparatus disposed opposing to the image carrier and capable of developing an electrostatic latent image formed on the image carrier with a developing agent including a toner particle and an aggregate of a toner dust powder having a smaller volume average particle size than a volume average particle size of the toner particle and alumina, thereby forming a developing agent image;

a transfer unit for transferring the developing agent image onto a material to be transferred;

a cleaning apparatus for recovering the developing agent remaining on the image carrier after transfer; and

a recycle system for feeding the recovered developing agent from the cleaning apparatus to the development apparatus and reusing it.

In addition, according to a further embodiment, as an example of a method for manufacturing the foregoing developing agent, there is a method for manufacturing a developing agent including

melt kneading a toner particle material mixture containing a coloring agent and a binder resin to from a kneaded material;

pulverizing the kneaded material;

classifying the obtained pulverized material to separate it into a toner particle and a tone fine powder;

mixing the toner dust powder and an alumina particle to form an aggregate; and

mixing the aggregate and the toner particle to form a toner.

The embodiments are hereunder described in more detail by reference to the accompanying drawings.

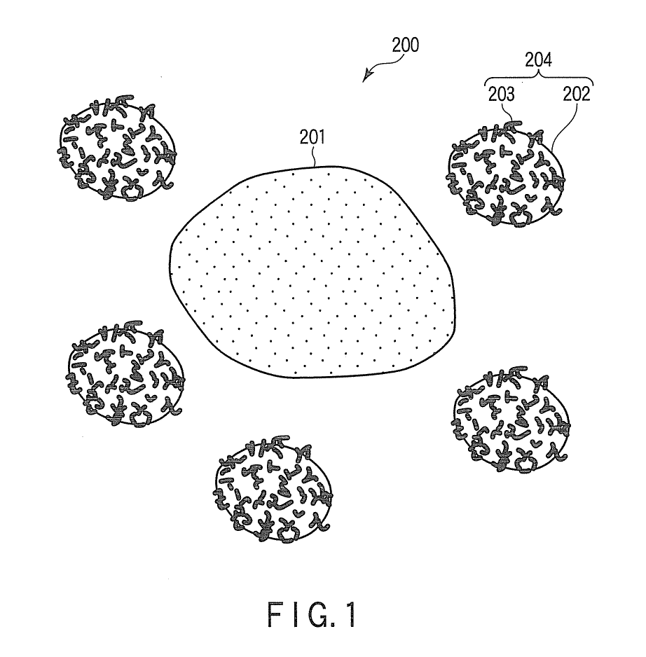

FIG. 1 shows a model diagram of a developing agent according to an embodiment.

As shown in FIG. 1, a developing agent 200 according to the embodiment is a mixture containing an aggregate 204 of a toner dust powder 203 and an alumina particle 202 and a toner particle 201. Here, the aggregate 204 is coexistent with the toner particle 201.

According to the embodiment, as described previously, by mixing a moderate amount of the aggregate obtained by mixing the toner dust powder and the alumina particle, with the toner particle, a cleaning effect against toner filming and the attachment of a paper dust onto a photoreceptor can be obtained.

A time for which the toner dust powder circulates within a pulverization and classification apparatus is short as compared with that in a toner having a usual volume average particle size. For that reason, the surface of the toner dust powder is in a pulverized coarse state as it is, so that it is easy to attract other fine particles. For that reason, when the toner dust powder is mixed with alumina, the toner dust powder and alumina may be easily aggregated. The aggregate of the toner dust powder and alumina in the toner is merely coexistent with the toner particle. The aggregate of the toner dust powder and alumina is easily picked apart during a time when the aggregate circulates in a recycle system of an image forming apparatus. The picked apart particle exhibits a favorable abrasive effect against the photoreceptor toner filming and paper dust.

The toner dust powder is meant to be a fine powder which is produced in a dry toner pulverization and classification step.

According to the embodiment, the toner particle may have a volume average particle size of from 6 to 9 μm. When the volume average particle size of the toner particle is less than 6 μm, the manufacturing costs of a toner tend to increase, whereas when it exceeds 9 μm, a resolving power of an outputted image tends to be lowered.

According to the embodiment, the toner dust powder may have a volume average particle size of from 1 to 3 μm. When the volume average particle size of the toner dust powder is less than 1 μm, cleaning properties against a fibrous paper dust (about 10 μm) tend to be lowered, whereas when it exceeds 3 μm, scratches on a drum tend to increase.

According to the embodiment, the aggregate may have a volume average particle size of from 1 to 5 μm. When the volume average particle size of the aggregate is less than 1 μm, cleaning properties against a fibrous paper dust (about 10 μm) tend to be lowered, whereas when it exceeds 5 μm, scratches on a drum tend to increase.

In the recycle system, after a first development step, a secondary aggregate of a toner dust powder and alumina having a volume average particle size of from 1 to 5 μm and existent in a fresh toner passes through the cleaning system likewise an untransferred toner. In that process, the cleaning effect against the attachment of a relatively large paper dust of about 10 μm on the photoreceptor surface is exhibited.

Thereafter, the secondary aggregate receives various stresses within the recycle system and is separated into an aggregate composed of only alumina having a volume average particle size of not more than 1 μm and a toner dust powder. Then, in a second development step, an aggregate (not more than 2 μm) composed, of only alumina exhibits a cleaning effect against the attachment of a small paper dust of about 2 μm.

According to the embodiment, a primary particle of alumina may have a volume average particle size of from 0.01 to 0.3 μm. When the volume average particle size of the primary particle of alumina is less than 0.01 μm, cleaning properties on a drum tend to be lowered, whereas when it exceeds 0.3 μm, scratches on a drum tend to be produced.

Also, according to the embodiment, a zirconium complex can be used as CCA in the toner. When the zirconium complex CCA is used, there is brought an effect for adequately controlling a secondary aggregation size with alumina. When other CCA is used, the aggregation becomes excessively large to an extent of 5 μm or more in terms of an average particle, so that there is a concern that the photoreceptor is scratched. Also, alumina is liberated from the toner dust powder, so that there may be the case where the cleaning effect against the attachment of a paper dust is not obtainable.

According to the embodiment, by mixing the toner dust powder of from 1 to 3 μm in terms of an average particle and the alumina particle of from 0.01 to 0.3 μm in terms of a primary particle and mixing a moderate amount of the aggregated secondary particle (1 to 5 μm) with the toner, a cleaning effect against the attachment of a paper dust onto the photoreceptor can be obtained.

As to the fine powder toner serving as a nucleus of the aggregate, in the case of a material obtained from the manufacturing step of a matrix particle toner, namely a material having the same material composition, image characteristics become the most favorable. However, so far as a resin of the same system is used, such a resin can be applied even when it is not identical. For example, when a binder resin of the matrix particle toner is a polyester and has a softening point of 58° C.±2.9° C., in the fine powder toner, a content of the binder resin in the fine powder toner can be varied to an extent of ±2 weight % relative to the matrix toner resin, and the fine powder toner can be applied so far as its softening point is 58° C.±5.8° C.

In order to regulate the aggregate so as to have a proper size, the particle size of the fine powder toner serving as a nucleus can be taken into consideration. In order to obtain a fine powder toner having a volume average particle size of from 1 to 3 μm, it would be better to use ELBOW-JET (manufactured by Matsubo Corporation) in a toner atomization and classification step. It is possible to obtain a fine powder toner having sharp particle size distribution as compared with other atomization and classification equipment.

As to a cohesive force between the fine powder toner and alumina in the secondary particle, a strong cohesive force to such an extent that the secondary particle is not picked apart during passing through the cleaning system at the first development is necessary. For that reason, mixing can be achieved in a 20-L Henschel mixer at a high speed of 2,000 min⁻¹ in terms of a mixing rotation rate for 3 minutes.

Also, it is possible to use an aluminosilicate in place of alumina of the secondary aggregate.

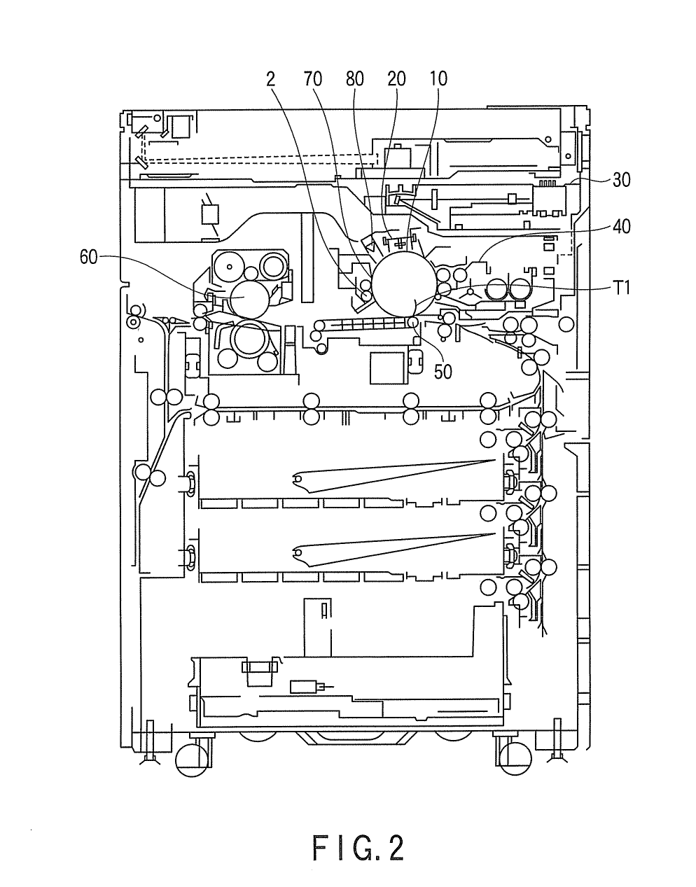

An example of a configuration of an image forming apparatus adopting a recycle system in a contact printing mode according to another embodiment is shown in FIG. 2.

This image forming apparatus is configured of a photoreceptor drum 10, a charging unit 20, an exposure apparatus 30, a development unit 40, a transfer apparatus 50, a fixing apparatus 60, a cleaning apparatus 70, a destaticization apparatus 80 and so on.

In the image forming apparatus having such a configuration, the photoreceptor drum 10 is rotated and driven by a non-illustrated drive section, and its surface is uniformly charged by the charging unit 20. Then, exposure is carried out by the exposure apparatus 30 on the basis of read image information, thereby forming an electrostatic latent image on the surface of this photoreceptor drum 10. This electrostatic latent image is converted into a visible image by a toner fed from the development unit 40.

Meanwhile, transfer paper is fed from a paper feed section toward the photoreceptor drum 10 during the formation of a toner image onto the photoreceptor drum 10. This transfer paper is sent out toward the transfer apparatus 50 disposed opposing to the photoreceptor drum 10 with timing of being superimposed on the toner image on the photoreceptor drum 10, and the toner image on the photoreceptor drum 10 is transferred onto the transfer paper in a transfer section T1. Thereafter, the transfer paper is mechanically separated from the photoreceptor drum 10 and then delivered into the fixing apparatus 60, whereby the toner image is fixed.

The residual toner remaining on the surface of the photoreceptor drum 10 after passing through the transfer section T1 is removed from the top of the photoreceptor drum 10 by the cleaning apparatus 70. Then, the resulting toner is delivered into the development unit 40 by a toner recycle apparatus 1A, and the toner is again used. Here, the toner recycle apparatus is described.

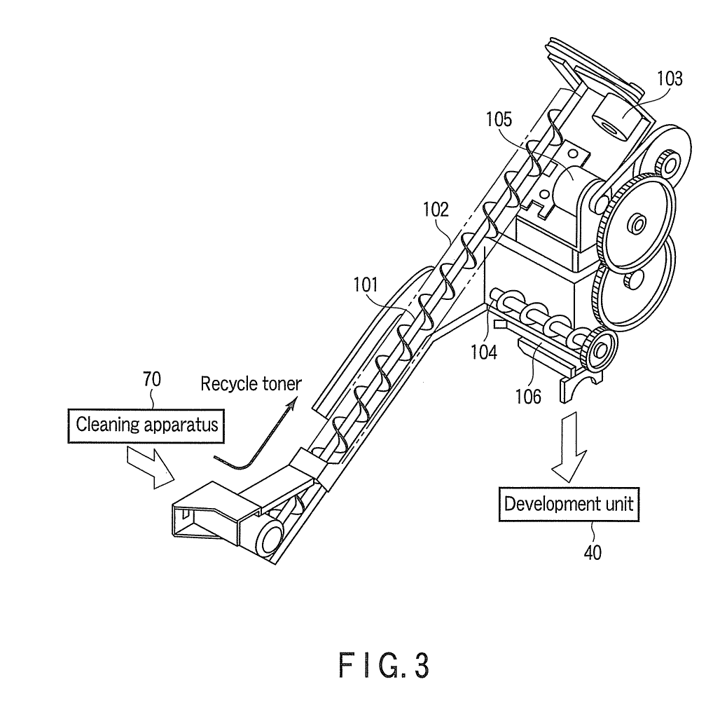

FIG. 3 shows an example of a toner recycle apparatus to be used in the image forming apparatus shown in FIG. 2.

The recycle toner is removed by the cleaning apparatus 70 and then delivered into the inside of a recycle hopper 104 by an auger 101 within a pipe 102 which is driven by a recycle toner delivery motor 103. In the recycle hopper 104, the recycle toner is moved into the development unit 40 by an auger 106 to be driven by a hopper motor 105 and again used. A residual charge on the surface of the photoreceptor drum 10 after the transferred residual toner is removed is removed by the destaticization apparatus 80.

Examples are hereunder shown, and the embodiments are more specifically described.

### Examples 1 to 5 and Comparative Examples 1 to 9

### Preparation of Toner Matrix Particle

A toner matrix particle is composed of the following material composition.

Binder resin: 100 weight parts

Carbon black: 5 weight parts

Antistatic agent, N5P01, manufactured by Clariant (Japan) K.K.: 1.5 weight parts

Natural wax, Carnauba No. 1: 4 weight parts

In Examples 1 to 5 and Comparative Examples 1 to 9, a polyester having a glass transition point temperature Tg of from 55 to 61° C. was used as the binder resin.

These materials were mixed in a 300-L Henschel mixer and then melt kneaded in a twin-screw kneader, PCM65 (manufactured by Ikegai Corporation).

Thereafter, the kneaded material was coarsely pulverized to a particle size of not more than 3 mm by a pin mill, further pulverized by a counter jet mill and classified by ELBOW-JET. A volume average particle size of the obtained matrix particle toner (1) was 8 μm in Examples 1 to 5 and Comparative Examples 1 to 5, 8 and 9; 4 μm in Comparative Example 6; and 12 μm in Comparative Example 7, respectively.

The volume average particle size of the matrix particle toner is show in the following Table 1.

### Preparation of Secondary Aggregate

In Examples 1 to 2 and Comparative Examples 1 to 9, a fine powder toner of from 1 to 3 μm obtained on the occasion of classifying the matrix particle toner by ELBOW-JET was used; and in Examples 3 to 5, a fine powder toner containing a polyester resin having a glass transition point temperature of from 52 to 64° C., which is different from the polyester resin used in the matrix particle toner, was used.

As an alumina particle to be mixed and aggregated with such a fine powder toner, one having a volume average particle size of 0.3 μm was used in Examples 1 to 4 and Comparative Examples 3 to 5 and 7 to 9 was used; one having a volume average particle size of 5 μm was used in Comparative Example 1; one having a volume average particle size of 1 μm was used in Comparative Example 2; and one having a volume average particle size of 0.1 μm was used in Comparative Example 6. In addition, in Example 5, an aluminosilicate particle having a volume average particle size of 0.3 μm was used in place of the alumina particle.

These two kinds of materials were mixed in a 20-L Henschel mixer at 2,000 min⁻¹ for 3 minutes, thereby obtaining a secondary aggregate (2).

A content of the alumina particle based on 100 weight % of the fine powder toner was 30 weight % in Examples 1 and 2 and Comparative Examples 6 to 9; 50 weight % in Examples 3 and 4; 0 weight % in Comparative Examples 1 to 3; 20 weight % in Comparative Example 4; and 60 weight % in Comparative Example 5, respectively. Also, in Example 5, a content of the aluminosilicate particle based on 100 weight % of the fine powder toner was 30 weight %.

Incidentally, an amount of alumina in the obtained aggregate is 23 weight % in Examples 1 and 2 and Comparative Examples 6, 7, 8 and 9; 50 weight % in Examples 3 and 4; 0 weight % in Comparative Examples 1 to 3; 17 weight % in Comparative Example 4; and 38 weight % in Comparative Example 5, respectively based on 100 weight % of the aggregate. Also, in Example 5, the content of the aluminosilicate particle based on 100 weight % of the aggregate is 23 weight %.

Also, a size of the obtained aggregate was 4 μm in Examples 1, 2 and 5 and Comparative Example 7; 4.5 μm in Examples 3 and 4 and Comparative Example 5; 3.5 μm in Comparative Example 4; 1.0 μm in Comparative Example 6, 0.5 μm in Comparative Example 8; and 8.0 μm in Comparative Example 9, respectively. Incidentally, Comparative Example 2 is concerned with only alumina, and a size of the aggregate was 4 μm.

The obtained results are shown in the following Table 2.

### Addition of Additives

The following materials (1) to (5) are mixed as toner materials.

(1) Toner matrix particle having a volume average particle size of from 6 to 9 μm

(2) Secondary aggregate

(3) Silica having a volume average particle size of 10 nm: 0.2 to 2.0 weight %

(4) Silica having a volume average particle size of 30 nm

(5) Lubricant

An addition amount of the secondary aggregate based on 100 weight % of the toner matrix particle was set up at 10, 20, 10, 20 and 20 weight % in Examples 1 to 5, respectively; and 0, 0, 0, 10, 20, 20, 20, 20 and 20 weight % in Comparative Examples 1 to 9, respectively.

An addition amount of alumina relative to the toner matrix particle is 0.027, 0.050, 0.045, 0.083 and 0.050 weight % in Examples 1 to 5, respectively; and 0.050, 0.100, 0.100, 0.018, 0.100, 0.050, 0.050, 0.050 and 0.050 weight % in Comparative Examples 1 to 9, respectively.

In addition, an addition amount of silica having a volume average particle size of 10 nm was set up at 1.0 weight % in all of Examples 1 to 5; and 1.0 weight % in all of Comparative Examples 1 to 9.

The obtained results, the binder resin and the resin used in the toner dust powder are shown in the following Table 2.

In addition, an addition amount of silica having a volume average particle size of 30 nm was set up 1.5 weight % in all of Examples 1 to 5; and 1.5 weight % in all of Comparative Examples 1 to 9.

Zinc stearate was used as the lubricant. An addition amount of the lubricant was set up at 0.3 weight % in all of Examples 1 to 5; and 0.3 weight % in all of Comparative Examples 1 to 9.

These materials (1) to (5) were mixed in a 20-L Henschel mixer at 1,000 min⁻¹ for 3 minutes, thereby obtaining a toner.

Subsequently, each of the obtained developing agents was applied to an image forming apparatus having the same configuration shown in FIG. 2, thereby examining cleaning properties against the attachment of paper dust of 10 μm, cleaning properties against the attachment of paper dust of not larger than 2 μm, image quality (resolving power), toner productivity and presence or absence of the generation of drum scratch.

### Cleaning Properties Against the Attachment of Paper Dust of 10 μm

After carrying out a printing test of 10,000 sheets of paper of an A4 size, a black solid image and a white paper image are printed, thereby examining cleaning properties against the attachment of paper dust of 10 μm.

The evaluation is made in such a manner that in both of the black solid image and the white paper image, the case where a defective portion is not found is designated as “Good”; the case where a small amount of a streaked defective image or the like is found is designated as “Fair”; and the case where a noticeable defective image is found is designated as “Bad”.

Cleaning Properties Against the Attachment of Paper Dust of not Larger than 2 μm

After carrying out a printing test of 10,000 sheets of paper of an A4 size, a halftone image is printed, thereby examining cleaning properties against the attachment of paper dust of not larger than 2 μm.

The evaluation is made in such a manner that in the halftone image, the case where a defective portion is not found is designated as “Good”; the case where an image unevenness is slightly found is designated as “Fair”; and the case where a considerable amount of an image uneven portion is found is designated as “Bad”.

### Image Quality (Resolving Power)

After carrying out a printing test of 10,000 sheets of paper of an A4 size, a No. 3 test chart of The Imaging Society of Japan is printed, thereby examining the image quality. The evaluation is made in such a manner that in the No. 3 test chart, the case where the resolving power is 5.6 or more is designated as “Good”; the case where the resolving power is from 4.0 to 5.0 is designated as “Fair”; and the case where the resolving power is not more than 3.6 is designated as “Bad”.

### Toner Productivity

Relative to a material weight after toner melt kneading, a weight (production yield) of a toner particle obtained after pulverization and classification is measured, thereby examining the toner productivity.

The evaluation is made in such a manner that the case where the production yield exceeds 65% is designated as “Good”; the case where the production yield is from 50 to 60% is designated as “Fair”; and the case where the production yield is less than 50% is designated as “Bad”.

### Presence or Absence of the Generation of Drum Scratch

After carrying out a printing test of 10,000 sheets of paper of an A4 size, a black solid image is printed, thereby examining the presence or absence of the generation of drum scratch. The evaluation is made in such a manner that in the black solid image, the case where a defective image portion is not found is designated as “Good”; the case where some streaks are slightly found is designated as “Fair”; and the case where a number of distinct streaks are found through visual inspection is designated as “Bad”.

The obtained results are shown in the following Table 3.

TABLE 1

| | Toner matrix | Alumina single | | | |
|---|---|---|---|---|---|
| | particle | material | Fine powder toner and alumina | | |
| | Volume average | Volume average | Addition amount of | Amount of alumina | Size of secondary |
| | particle size of | particle size of | alumina based on 100 | in secondary | aggregated particle |
| | toner matrix | alumina primary | wt % of fine powder | aggregated | (toner dust powder + |
| | particle (μm) | particle (μm) | toner (wt %) | particle (wt %) | alumina) (μm) |
| Example 1 | 8 | 0.3 | 30 | 23 | 4 |
| Example 2 | 8 | 0.3 | 30 | 23 | 4 |
| Example 3 | 8 | 0.3 | 50 | 33 | 4.5 |
| Example 4 | 8 | 0.3 | 50 | 33 | 4.5 |
| Example 5 | 8 | Aluminosilicate: | 30 | 23 | 4 |
| | | 0.3 | | | |
| Comparative | 8 | 5 | 0 | 0 | — |
| Example 1 | | | | | |
| Comparative | 8 | 1 | 0 | 0 | 4 (only alumina) |
| Example 2 | | | | | |
| Comparative | 8 | 0.3 | 0 | — | — |
| Example 3 | | | | | |
| Comparative | 8 | 0.3 | 20 | 17 | 3.5 |
| Example 4 | | | | | |
| Comparative | 8 | 0.3 | 60 | 38 | 4.5 |
| Example 5 | | | | | |
| Comparative | 4 | 0.1 | 30 | 23 | 1 |
| Example 6 | | | | | |
| Comparative | 12 | 0.3 | 30 | 23 | 4 |
| Example 7 | | | | | |
| Comparative | 8 | 0.3 | 30 | 23 | 0.5 |
| Example 8 | | | | | |
| Comparative | 8 | 0.3 | 30 | 23 | 8 |
| Example 9 | | | | | |

TABLE 2

| | Toner and additive | | | |
|---|---|---|---|---|
| | Addition amount of | Addition amount of | | |
| | secondary aggregate | alumina relative to | | |
| | relative to matrix | matrix particle | Resin characteristics | |
| | particle toner (wt %) | toner (wt %) | Matrix particle toner | Fine powder toner |
| Example 1 | 10 | 0.027 | Polyester, Tg: 55 to 61° C. | Polyester, Tg: 55 to 61° C. |
| Example 2 | 20 | 0.050 | Polyester, Tg: 55 to 61° C. | Polyester, Tg: 55 to 61° C. |
| Example 3 | 10 | 0.045 | Polyester, Tg: 55 to 61° C. | Polyester, Tg: 52 to 64° C. |
| Example 4 | 20 | 0.083 | Polyester, Tg: 55 to 61° C. | Polyester, Tg: 52 to 64° C. |
| Example 5 | 20 | 0.050 | Polyester, Tg: 55 to 61° C. | Polyester, Tg: 52 to 64° C. |
| Comparative | — | 0.050 | Polyester, Tg: 55 to 61° C. | Polyester, Tg: 55 to 61° C. |
| Example 1 | | | | |
| Comparative | — | 0.100 | Polyester, Tg: 55 to 61° C. | Polyester, Tg: 55 to 61° C. |
| Example 2 | | | | |
| Comparative | — | 0.100 | Polyester, Tg: 55 to 61° C. | Polyester, Tg: 55 to 61° C. |
| Example 3 | | | | |
| Comparative | 10 | 0.018 | Polyester, Tg: 55 to 61° C. | Polyester, Tg: 55 to 61° C. |
| Example 4 | | | | |
| Comparative | 20 | 0.100 | Polyester, Tg: 55 to 61° C. | Polyester, Tg: 55 to 61° C. |
| Example 5 | | | | |
| Comparative | 20 | 0.050 | Polyester, Tg: 55 to 61° C. | Polyester, Tg: 55 to 61° C. |
| Example 6 | | | | |
| Comparative | 20 | 0.050 | Polyester, Tg: 55 to 61° C. | Polyester, Tg: 55 to 61° C. |
| Example 7 | | | | |
| Comparative | 20 | 0.050 | Polyester, Tg: 55 to 61° C. | Polyester, Tg: 55 to 61° C. |
| Example 8 | | | | |
| Comparative | 20 | 0.050 | Polyester, Tg: 55 to 61° C. | Polyester, Tg: 55 to 61° C. |
| Example 9 | | | | |

TABLE 3

| | Evaluation results | | | | |
|---|---|---|---|---|---|
| | | Cleaning | | | |
| | Cleaning | properties against | | | |
| | properties against | the attachment of | | | Presence or absence |
| | the attachment of | paper dust of not | Image quality | Toner | of the generation |
| | paper dust of 10 μm | larger than 2 μm | (resolving power) | productivity | drum scratch |
| Example 1 | Good | Good | Good | Good | Good |
| Example 2 | Good | Good | Good | Good | Good |
| Example 3 | Good | Good | Good | Good | Good |
| Example 4 | Good | Good | Good | Good | Good |
| Example 5 | Good | Good | Good | Good | Good |
| Comparative | Good | Fair | Good | Good | Fair |
| Example 1 | | | | | |
| Comparative | Fair | Good | Good | Good | Good |
| Example 2 | | | | | |
| Comparative | Fair | Good | Good | Good | Good |
| Example 3 | | | | | |
| Comparative | Fair | Good | Good | Good | Good |
| Example 4 | | | | | |
| Comparative | Good | Good | Good | Good | Fair |
| Example 5 | | | | | |
| Comparative | Good | Good | Good | Fair | Good |
| Example 6 | | | | | |
| Comparative | Good | Good | Fair | Good | Good |
| Example 7 | | | | | |
| Comparative | Fair | Good | Good | Good | Good |
| Example 8 | | | | | |
| Comparative | Good | Good | Good | Good | Fair |
| Example 9 | | | | | |

Comparative Example 2 is weaker in the cohesive force than Examples 1 to 4. The secondary aggregation strength of the Examples is middle between Comparative Examples 1 and 2.

According to the embodiments, the attachment of a toner and the attachment of a paper dust onto the photoreceptor can be prevented, and a long life can be realized.

According to the embodiments, a developing agent corresponding to a long life, which is used in a an image forming apparatus adopting contact printing mode and a recycle system of waste toners (untransferred toners), is obtainable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising a toner particle and an aggregate of a toner dust powder having a smaller volume average particle size than a volume average particle size of the toner particle and alumina.

2. The developing agent according to claim 1, wherein the toner particle has a volume average particle size of from 6 to 9 μm.

3. The developing agent according to claim 1, wherein the toner dust powder has a volume average particle size of from 1 to 3 μm.

4. The developing agent according to claim 1, wherein the aggregate has a volume average particle size of from 1 to 5 μm.

5. The developing agent according to claim 1, wherein a primary particle of the alumina has a volume average particle size of from 0.01 to 0.3 μm.

6. The developing agent according to claim 1, wherein the toner particle further contains a zirconium complex as an antistatic agent.

7. An image forming apparatus comprising an image carrier; a development apparatus disposed opposing to the image carrier and capable of developing an electrostatic latent image formed on the image carrier with a developing agent including a toner particle and an aggregate of a toner dust powder having a smaller volume average particle size than a volume average particle size of the toner particle and alumina to form a developing agent image; a transfer unit configured to transfer the developing agent image onto a material to be transferred; a cleaning apparatus configured to recover the developing agent remaining on the image carrier after transfer; and a recycle system configured to feed the recovered developing agent from the cleaning apparatus to the development apparatus and reusing it.

8. The apparatus according to claim 7, wherein the toner particle has a volume average particle size of from 6 to 9 μm.

9. The apparatus according to claim 7, wherein the toner dust powder has a volume average particle size of from 1 to 3 μm.

10. The apparatus according to claim 7, wherein the aggregate has a volume average particle size of from 1 to 5 μm.

11. The apparatus according to claim 7, wherein a primary particle of the alumina has a volume average particle size of from 0.01 to 0.3 μm.

12. The apparatus according to claim 7, wherein the toner particle further contains a zirconium complex as an antistatic agent.

13. A method of manufacturing a developing agent comprising:
melt kneading a toner particle material mixture containing a coloring agent and a binder resin to from a kneaded material;
pulverizing the kneaded material to form a pulverized material;
classifying the pulverized material to separate it into a toner particle and a toner dust powder;
mixing the toner dust powder and an alumina particle to form an aggregate; and
mixing the aggregate and the toner particle to form a toner.

14. The method according to claim 13, wherein the toner particle has a volume average particle size of from 6 to 9 μm.

15. The method according to claim 13, wherein the toner dust powder has a volume average particle size of from 1 to 3 μm.

16. The method according to claim 13, wherein the aggregate has a volume average particle size of from 1 to 5 μm.

17. The method according to claim 13, wherein a primary particle of the alumina has a volume average particle size of from 0.01 to 0.3 μm.

18. The method according to claim 13, wherein the toner particle further comprises a zirconium complex as an antistatic agent.

19. The method according to claim 13, wherein the toner dust powder and the alumina particle are mixed in a 20-L Henschel mixer at 2,000 min⁻¹ for 3 minutes.
